(19) United States
(12) Patent Application Publication
(10) Pub. No.: US 2004/0138915 A1
(43) Pub. Date: Jul. 15, 2004

(54) Management method, management terminal, and program for managing representatives in e-commerce

(76) Inventors: Keisuke Kataoka, Kanagawa (JP); Atsushi Hanai, Kanagawa (JP); Kohichi Yuasa, Tokyo (JP); Sachiko Misumi, Tokyo (JP); Maki Satoh, Kanagawa (JP); Tatsuto Torikai, Kanagawa (JP); Eiji Shinohara, Kanagawa (JP); Akihiro Kanomune, Kanagawa (JP); Mutsuko Takahashi, Tokyo (JP)

Correspondence Address: MORRISON & FOERSTER LLP, 1650 TYSONS BOULEVARD, SUITE 300, MCLEAN, VA, 22102, US

(21) Appl. No.: 10/721,788

(22) Filed: Nov. 26, 2003

(30) Foreign Application Priority Data
Nov. 27, 2002 (JP) 2002-343487

(51) Int. Cl. G06F 17/60

(52) U.S. Cl. 705/1; 705/7; 705/26

(57) ABSTRACT

A management terminal stores representative information indicating a plurality of representatives who are in charge of an organization that a user belongs to, and selection information indicating a selected representative that the user selected from the plurality of representatives. The management terminal generates data of a first screen, which displays the selected representative that the selection information indicates, and which is possible for the user to select another representative than the selected representative. Then, the management terminal sends the generated data of the first screen to a user terminal, which is operated by the user. The user terminal presents the first screen to the user, using the provided data of the first screen.

### BACKGROUND OF THE INVENTION

1. Field of the Invention

The present invention relates to a management method, a management terminal, and a program for managing representatives in e-commerce, which is carried out via a network.

2. Description of the Related Art

An e-commerce system for sales of merchandise via the Internet is realized, by the rapid spread of Internet technology. In the e-commerce system, a customer who purchases merchandise accesses to a commerce web site, which is provided by a sales company that sells merchandise, using a terminal device, such as a personal computer. The customer carries out purchasing procedures of a desired merchandise, on the web site for commerce, operating the terminal device.

In recent years, a system which includes a function for making support by a salesperson possible, in the same way as counter selling at stores, in e-commerce, by inserting information of the salesperson in a web page for e-commerce, is considered.

However, in the system as above, it is general for one salesperson to be in charge of e-commerce. Namely, one representative, who is in charge of e-commerce, accepts various inquiries from customers, as a contact person of sales service. In a case where the representative who is to be a contact person receives inquiries about merchandise that is not of his/her specialty, the representative has to ask a salesperson who handles that merchandise. Then, the representative provides the answer that is obtained from the salesperson who is in charge of that merchandise. Therefore, processing of inquiries from customers, is inefficient.

Additionally, in the same way as counter selling in stores, even in e-commerce, because customers tend to have a desire to select a salesperson, according to the situation that he/she is in, a system that can meet this desire, is required.

### SUMMARY OF THE INVENTION

The present invention has been made in consideration of the above problem. An object of the present invention is to provide a management method, a management terminal, and a program for managing representatives, thereby high efficiency of sales affairs can be realized in e-commerce.

Another object of the present invention is to provide a management method, a management terminal, and a program for managing representatives, thereby customers can select the representatives.

To achieve the above objects, a management method according to a first aspect of the present invention, for managing representatives in e-commerce system that is carried out using computers, comprising:

a first storing step of storing, by a management terminal that manages the representatives, representative information indicating a plurality of representatives who are in charge of an organization that a user belongs to, and selection information indicating a selected representative who is selected from a plurality of representatives by the user;

a screen generating step of generating, by the management terminal, data of a first screen which indicates the selected representative that the selection information indicates, where it is possible for the user to select on the screen, another representative than the selected representative, from the plurality of representatives that the representative information indicates;

a screen sending step of sending, by the management terminal, data of the first screen to a user terminal operated by the user; and

a displaying step of displaying, by the user terminal, the first screen by using the provided data of the first screen.

The management method may further comprise:

an information sending step of sending, by the user terminal, representative change information indicating another representative selected by the user to the management terminal, in a case where the user selects another representative on the first screen; and

an updating step of updating, by the management terminal, the selection information, using the provided representative change information, and by this, setting another representative that the user selected, as a newly selected representative.

The first screen may be for displaying information of merchandise, which the management terminal provides.

The first screen is for inputting contact content to the selected representative from the user, and may indicate the selected representative as a contact destination.

The management method may further comprise;

a first providing step of providing contact content that the user input in the first screen, by the user terminal, to the management terminal; and

a second providing step of providing, by the management terminal, the provided contact content to the selected representative.

The management method may further comprise an information sending step of sending, by the user terminal, contact destination change information indicating another representative that the user selected, to the management terminal, in a case where the user selects another representative on the first screen, wherein

the second providing step may comprise a step of providing the contact content, by the management terminal, to another representative that the contact change information indicates.

The second providing step may comprise a step of providing contact content from the user, by e-mail.

The management method may further comprise:

a second storing step of storing, by the management terminal, user information concerning a plurality of users who belong to the organization; and

a notifying step of notifying, by the management terminal, change of representative to each of the plurality of users that the user information indicates, in a case where at least one of the plurality of representatives who are in charge of the organization changes.

The notifying step may comprise a step of notifying each of the plurality of users of the change of representative, by the management terminal sending e-mail indicating change of the representative, to each of the plurality of users.

A management terminal according to a second aspect of the present invention, manages representatives in e-commerce, using a computer, comprising:

a memory, which stores representative information indicating a plurality of representatives who are in charge of an organization that a user belongs to, and selection information indicating a selected representative who is selected from the plurality of representatives by the user;

a screen generating unit that generates data of a first screen, which displays the selected representative that the selection information indicates, and which is possible for the user to select another representative than the selected representative on the first screen; and

a screen sending unit which sends data of the first screen to a user terminal that the user uses, so that the first screen is displayed on the user terminal.

The management terminal may further comprise an updating unit, which updates the selection information, using representative change information provided from the user terminal indicating another representative that the user selected, and by this, may set another representative that the user selected as a newly selected representative, in a case where the user selects another representative on the first screen.

The first screen may indicate information of merchandise, which the management terminal provides.

The first screen may be for inputting contact content to the selected representative from the user, and may indicate the selected representative as the contact destination.

The management terminal may comprise a providing unit that provides the contact content which is input on the first screen by the user, and is provided from the user terminal, to the selected representative.

The providing unit may provide the contact content to another representative, which is indicated by a contact destination change information indicating another representative that the user selected on the first screen, and which is provided from the user terminal, in a case where the user selects another representative on the first screen.

The providing unit may provide the contact content from the user terminal, by e-mail.

The memory may store user information concerning a plurality of users who belong to the organization, and the management terminal may further comprise a notifying unit which notifies change of representative to each of the plurality of users that the user information indicates, in a case where at least one of the plurality of representatives who are in charge of the organization changes.

The notifying unit may notify each of the plurality of users of the change of representative, by sending e-mail indicating the change of representative to each of the plurality of users.

A program for controlling a computer to function as a management terminal, according to a third aspect of the present invention, manages representatives in e-commerce, comprising:

a memory which stores representative information indicating a plurality of representatives who are in charge of an organization that a user belongs to, and selection information indicating a selected representative who is selected from the plurality of representatives by the user;

a screen generating unit that generates data of a first screen, which displays the selected representative that the selection information indicates, and which is possible for the user to select another representative than the selected representative; and

a screen sending unit which sends data of the first screen to a user terminal that the user uses, so that the first screen is displayed on the user terminal.

### BRIEF DESCRIPTION OF THE DRAWINGS

These objects and other objects and advantages of the present invention will become more apparent upon reading of the following detailed description and the accompanying drawings in which:

FIG. 1 is a diagram showing a structure of an e-commerce system, according to an embodiment of the present invention;

FIG. 2 is a diagram showing a structure of a server, which is applied in the e-commerce system of FIG. 1;

FIG. 3 is a diagram showing an example of a data structure of user information, which the server in FIG. 2 stores;

FIG. 4 is a diagram showing an example of a data structure of salesperson information, which the server in FIG. 2 stores;

FIG. 5 is a diagram showing an example of a data structure of representative information, which the server in FIG. 2 stores;

FIG. 6 is a diagram showing an example of a data structure of selection information, which the server in FIG. 2 stores;

FIG. 7 is a diagram showing an example of a commerce screen, which a user terminal that is applied in the e-commerce system in FIG. 1 displays;

FIG. 8 is a diagram showing an example of an introduction screen, which the user terminal displays;

FIG. 9 is a diagram showing an example of a contact screen, which the user terminal displays;

FIG. 10 is a diagram showing an example of an e-mail message that the server generates at mail sending processing;

FIG. 11 is a diagram for describing operation of the e-commerce system; and

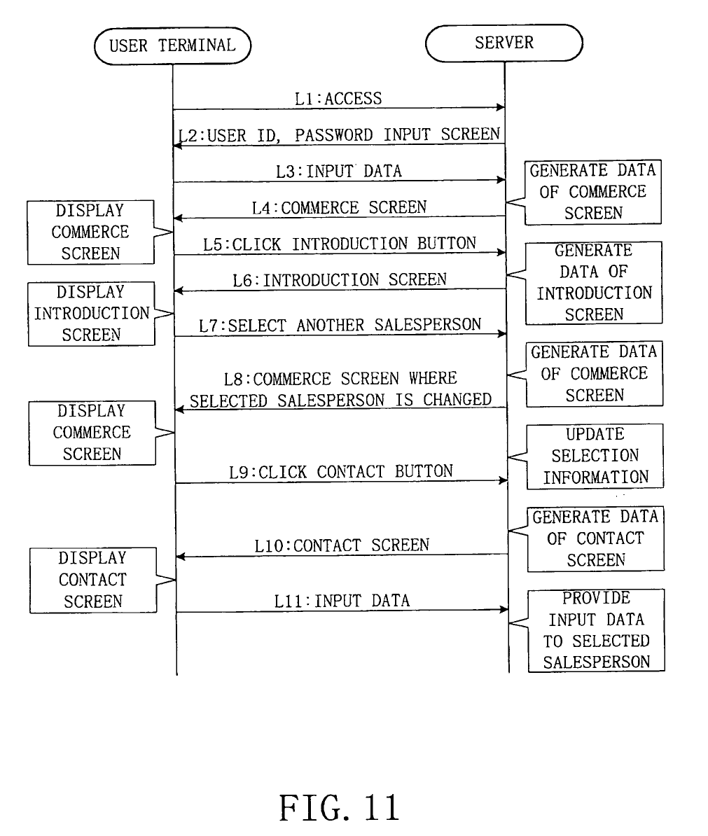

FIG. 12 is a flowchart for describing change notification processing that the server carries out.

### DETAILED DESCRIPTION OF THE PREFERRED EMBODIMENT

An e-commerce system according to the embodiment of the present invention will be described with reference to the drawings. An e-commerce system for a sales company that sells merchandise, to carry out e-commerce with a customer company that buys merchandise, via Internet, etc., will be described.

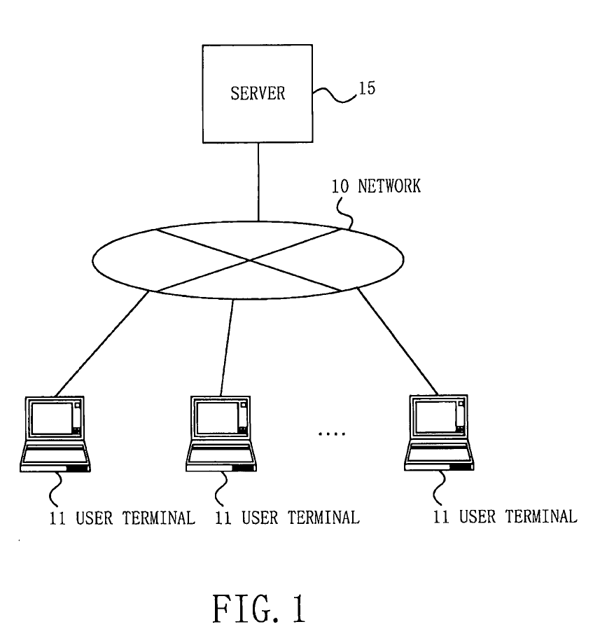

FIG. 1 is a diagram that shows a structure of an e-commerce system according to the embodiment of the present invention. As shown, the e-commerce system comprises user terminals 11 and a server 15, which are connected to each other via a network 10.

The network 10 comprises the Internet, etc. The user terminal 11 and the server 15 send/receive information via the network 10.

The user terminal 11 comprises a work station or a personal computer, etc., that is placed at a customer company, and is operated by members (users) of the customer company. The user terminal 11 comprises a control unit including a CPU (Central Processing Unit), a storing unit including a RAM (Random Access Memory) and a ROM (Read Only Memory), a display unit including a liquid crystal display, an input unit including a keyboard and a mouse, and a communication control unit including a communication interface circuit. The control unit of the user terminal 11 realizes browser functions for browsing various web pages on the Internet and e-mail functions, for sending/receiving e-mail, etc., by executing programs that are stored in the storing unit.

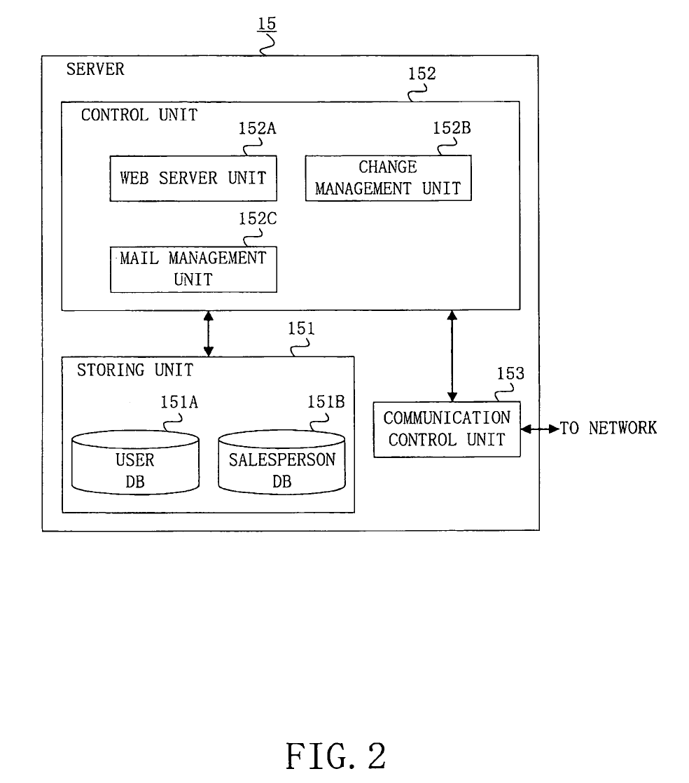

The server 15 comprises a workstation or a personal computer, etc., that is placed at a sales company, and is used by members in the sales company. The server 15, for example as shown in FIG. 2, comprises a storing unit 151, a control unit 152, and a communication control unit 153, and provides e-commerce websites, etc., for sales of merchandise, via the network 10.

The storing unit 151 comprises a RAM and a ROM. The storing unit 151 stores operation programs that are executed by the control unit 152, various data required for the processing executed by the control unit 152, and form data of e-mail that is used in a mail sending processing, to be described later. The storing unit 151 comprises a user DB (Data Base) 151A and a salesperson DB 151B, etc.

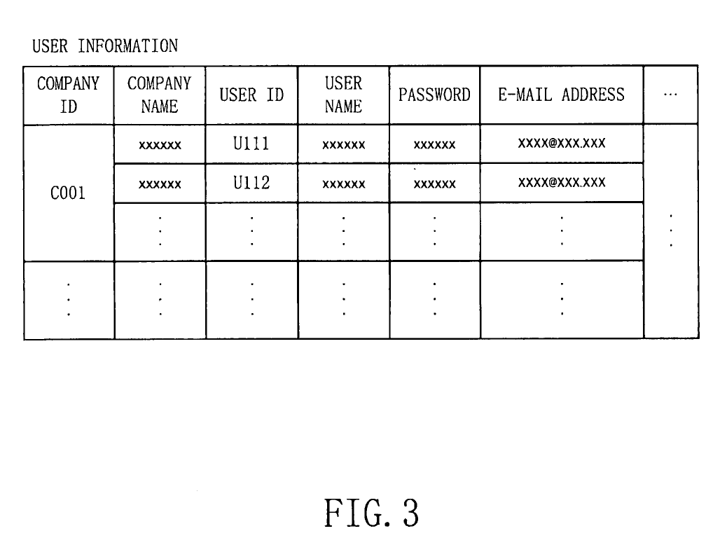

The user DB 151A stores information representing each user that uses the e-commerce system. For example, as shown in FIG. 3, user information includes information such as, ID (company ID) of the customer company that the user belongs to, name of the customer company, user ID of the user, user name, password, and e-mail address of the user, etc.

The user information is generated by a predetermined registering processing, which is carried out by using information concerning the user that is provided from the user terminal 11, which accesses to the predetermined website that the server 15 provides or information concerning the user that is provided from a computer within the sales company, which is connected by LAN (Local Area Network) etc., to the server 15. The computer within the sales company is for example a management terminal (not shown) which manages the server 15. An operator of the management terminal operates the management terminal, and inputs information representing the user that is written in a predetermined registration form, etc. The management terminal provides the input information concerning the user to the server 15, in accordance with the operation of the operator.

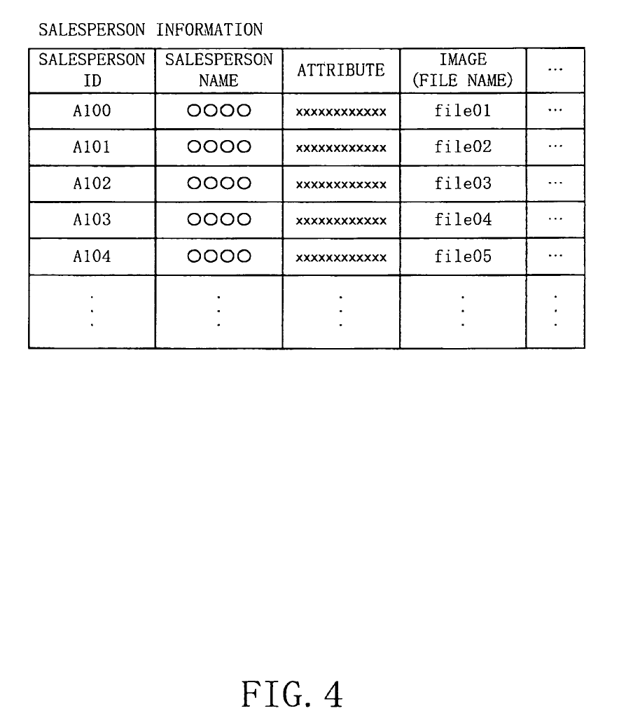

The salesperson DB 151B stores salesperson information concerning each salesperson that uses the e-commerce system. For example, as shown in FIG. 4, the salesperson information includes, salesperson ID, name of salesperson, and attribute of salesperson (belonging department, responsible area of merchandise, etc.), and image of salesperson (facial portrait, illustration, etc.), etc.

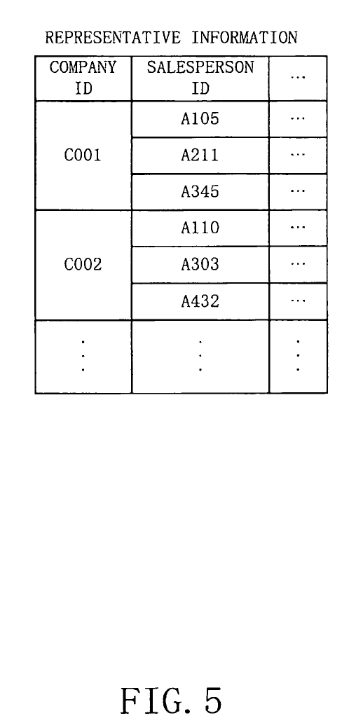

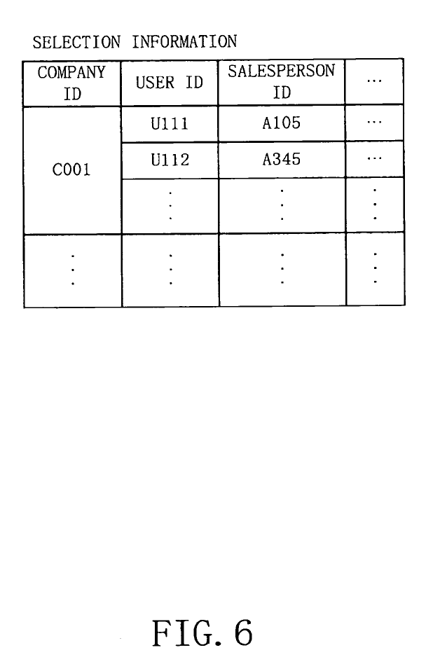

The salesperson DB 151B also stores representative information that shows which customer company each salesperson is in charge of, and selection information that shows which user selected each salesperson that is in charge of each customer company. An example of the representative information is shown in FIG. 5, and an example of the selection information is shown in FIG. 6. For example, the representative information in FIG. 5 shows that salespeople who have the salesperson IDs of “A105”, “A211 ”, and “A345” are in charge of the customer company that has the company ID “C001”. The selection information in FIG. 6 shows that among the users who belong to the customer company that has the company ID “C001”, the user who has the user ID “U111” selects the salesperson that has the salesperson ID “A105”, and the user who has the user ID “U112” selects the salesperson that has the salesperson ID “A345”.

The control unit 152 comprises a CPU, and operates according to operation programs, etc., that are stored in the storing unit 151. For example, the control unit 152 carries out the predetermined registering processing of above. The control unit 152 logically realizes a web server unit 152A, a change management unit 152B, and a mail management unit 152C, etc., which will be described below, by executing operation programs, etc., stored in the storing unit 151.

The web server unit 152A carries out a predetermined log-in processing, in response to a log-in request that are provided by the user terminal 11. Concretely, the web server unit 152A accepts user ID and password that are provided by the user terminal 11, responding to the log-in request from the user terminal 11. Then, the web server unit 152A carries out a predetermined authentication processing, applying the provided user ID and password, and permits or denies log-in of the user, in accordance with the authentication result.

In a case where log-in of the user is permitted, the web server unit 152A generates data of a commerce screen (web page) for the user that logged-in, applying salesperson information, representative information, and selection information, etc that are stored in the salesperson DB 151B. The web server unit 152A sends the generated data of the commerce screen to the user terminal 11. The user terminal 11 displays the commerce screen, applying data that is provided by the web server unit 152A.

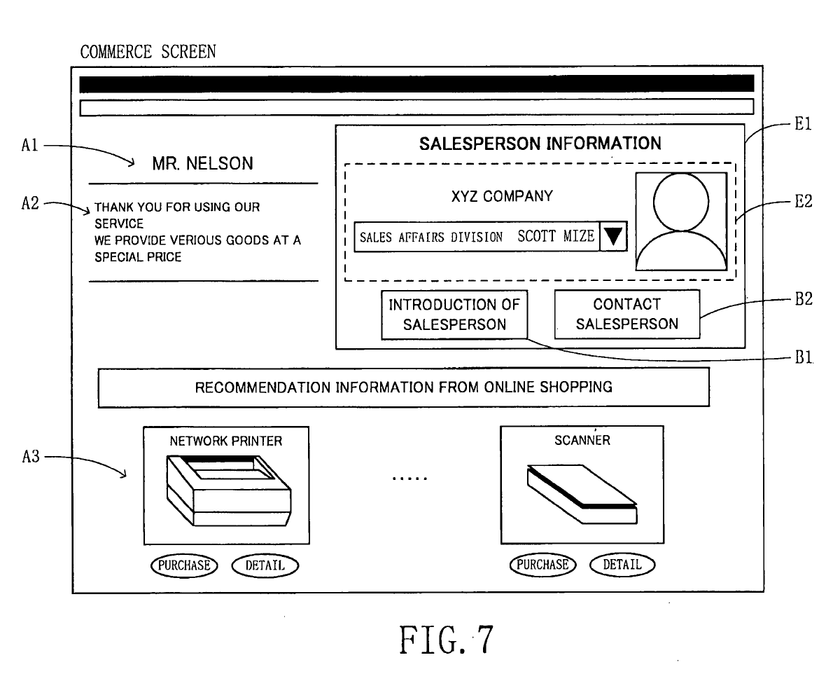

The commerce screen is a screen for presenting information of merchandise, and accepting orders of merchandise, etc. Processing concerning acceptance of orders, is the same as the processing in e-commerce systems applying the conventional web. For example, as shown in FIG. 7, a user name A1, a message to the user A2, and information of merchandise A3, etc. are shown in the commerce screen. Additionally, in the commerce screen, as shown in the drawing, an area E1 for displaying information concerning salespeople, is provided.

An introduction button B1, an area E2 for displaying information of the selected salesperson, and a contact button B2 are provided in the area E1.

The introduction button B1 is provided to change to an introduction screen (webpage) that shows detailed information of the salespeople who are in charge of the customer company that the user belongs to. When the user clicks the introduction button B1, the user terminal 11 sends information indicating that the introduction button B1 has been clicked, to the server 15. The web server unit 152A, in response to the information that is provided by the user terminal 11, generates data of the introduction screen, applying salesperson information and representative information that are stored in the salesperson DB 151B. Then, the web server unit 152A sends the generated data of the introduction screen to the user terminal 11. The user terminal 11 displays the introduction screen, applying the data that is provided from the web server unit 152A.

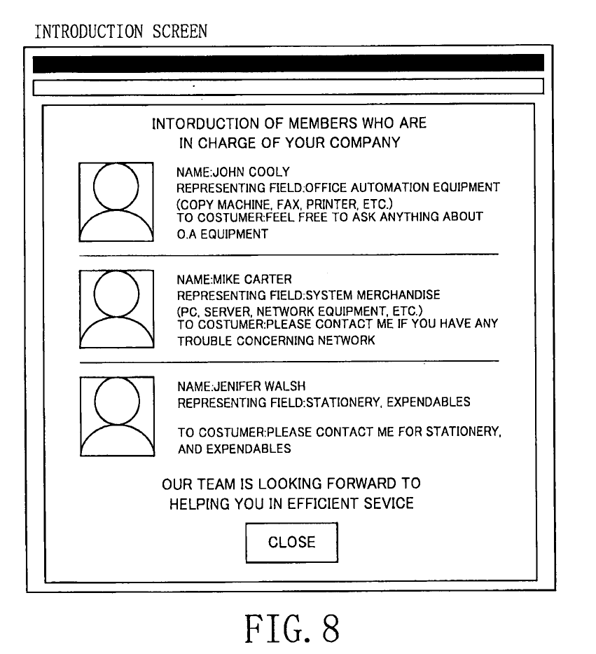

For example, as shown in FIG. 8, information (for example, name, responsible area of merchandise, message to customers, etc.) concerning each salesperson who is in charge of the customer company that the user belongs to, is shown in the introduction screen. Data of the introduction screen may be generated according to each customer company beforehand, and stored in the storing unit 151. In this case, the web server unit 152A reads out the data of the introduction screen from the storing unit 151, in response to the information that indicates that the introduction button B1 has been clicked, and sends the read data of the introduction screen to the server 11.

Image, name, and attribute (belonging department, etc.), etc., of the selected salesperson, namely the salesperson that the user selected, out of the salespeople who are in charge of the customer company that the user belongs to, are displayed in the area E2. The selected salesperson is a contact man for the user in e-commerce. It may be shown in the area E2 that the selected salesperson is the contact man for the user in e-commerce. In a situation where it is before the user selects a salesperson, for example in a case where the user accesses to the server 15 for the first time, etc., an image, name, and attribute, etc., of the salesperson who is designated beforehand by for example the sales company are displayed in the area E2.

The section in the area E2 that displays name is structured so that the user can select another salesperson by a pull down menu. When the user selects another salesperson by operating the user terminal 11, the user terminal 1 sends information that shows the salesperson that the user selected, to the server unit 15. The web server unit 152A, in response to the information provided by the user terminal 11, reads the image, name, attribute, etc., of the selected another salesperson from the salesperson DB 151B. Then, the web server unit 152A generates data of the commerce screen that includes the area E2 which shows the read out information concerning another salesperson, and sends the data to the user terminal 11. The web server unit 152A updates selection information in the salesperson DB 151B, according to selection of the user.

The contact button B2 is provided to change to a contact screen (webpage) for inputting contact content (content that the user wants to convey to the salesperson) from the user to the salesperson. When the user clicks the contact button B2, the user terminal 11 sends information indicating that the contact button B2 has been clicked, to the server 15. The web server unit 152A of the server 15, in response to the information that is provided by the user terminal 11, generates data of the contact screen, applying user information that is stored in the user DB 151A and salesperson information and selection information that are stored in the salesperson DB 151B, etc. Then, the web server unit 152A sends the generated data of the contact screen to the user terminal 11. The user terminal 11 displays the contact screen, applying the data that is provided from the web server unit 152A.

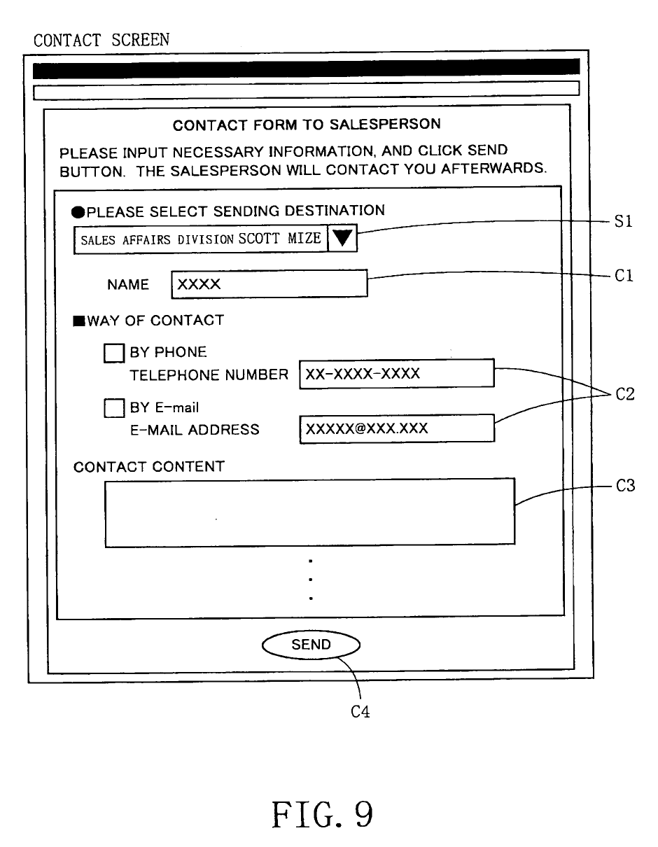

For example, as shown in FIG. 9, a selection box S1 that shows the salesperson who is to be the contact destination, an input box C1 for inputting the name of the user, an input box C2 for inputting the contact destination of the user, and an input box C3 for inputting contact content to the salesperson are provided in the contact screen. For example, the name and belonging department of the selected salesperson are displayed in the selection box S1. The selection box S1 is made so that the user can select another salesperson as the contact destination, by a pull down menu. The name and contact destination (telephone number, e-mail address, etc.) of the user are read out from the user information in the user DB 151A, and displayed. The user inputs the contact content to the salesperson to the input box C3, operating the user terminal 11. If necessary, the user selects another salesperson as a contact destination, and changes his/her name, telephone number, and/or e-mail address. When the user clicks a send button C4 that is provided in the contact screen, the user terminal 11 sends the input data that is input in the contact screen to the server 15. The web server unit 152A of the server 11 stores input data that is provided from the user terminal 11 to the storing unit 151. Then, the web server unit 152A provides the stored input data to the salesperson who was selected as the contact destination.

The providing method of the input data is arbitrary. For example, the input data may be provided by e-mail. In this case, e-mail addresses of salespeople are registered beforehand, as a part of the salesperson information. The control unit 152 reads out the e-mail address of the salesperson who was selected as the contact destination from the salesperson DB 151B. Then, the control unit 152 sends the input data that is stored in the storing unit 151 to the read out e-mail address, by e-mail. The input data may be provided to the salesperson when the salesperson logs-in to the server 15. In this case, the control unit 152 carries out the predetermined authentication processing applying the ID and password that are provided from the terminal device that the salesperson uses, and permits or denies log-in of the salesperson. In a case where it is determined that the log-in of the salesperson is permitted, the control unit 152 determines whether or not an input data for the salesperson who logged-in, is stored in storing unit 151. In a case where it is determined that data is stored in storing unit 151, the control unit 152 obtains the input data for the salesperson who logged-in from the storing unit 151, and sends the data to the terminal device that the salesperson who logged-in operates.

The change management unit 152B carries out processing concerning change of the salesperson who is in charge of the customer company. Change instruction of the salesperson is provided together with change information that shows content of the change, from for example, a computer in the sales company that is possible to be connected to the server 15. The change information shows for example, company ID of the customer company whose salesperson is to be changed, salesperson ID of the salesperson who will no longer be in charge, and salesperson ID of the salesperson who will newly be added to be in charge, etc.

The change management unit 152B, in response to the provided change instructions, specifies representative information that includes the company ID that the provided change information indicates. Then, the change management unit 152B deletes the salesperson ID of the salesperson who will no longer be in charge from the specified representative information, and adds the salesperson ID of the salesperson who is to be newly added to be in charge to the specified representative information. The change management unit 152B provides the provided change information to the mail management unit 152C.

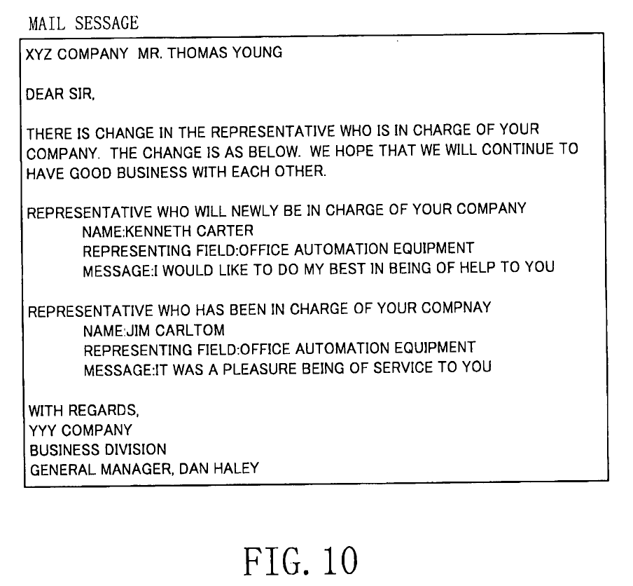

The mail management unit 152C, in response to the change information that is provided from the change management unit 152B, carries out mail sending processing for notifying the change of salesperson to each user. Concretely, the mail management unit 152C obtains user information of the users who belong to the customer company that has the company ID which the provided change information indicates, from the user DB 151A. Subsequently, the mail management unit 152C obtains salesperson information and representative information which includes the company ID that the provided change information indicates, from the salesperson DB 151B. The mail management unit 152C obtains form data of e-mail for notifying the change of salesperson. The mail management unit 152C generates an e-mail message which notifies the change of salesperson, for example as shown in FIG. 10, applying the obtained user information, salesperson information, representative information and form data. Then, the mail management unit 152C respectively sets each concerned user's e-mail address as the e-mail destination, and sends the generated e-mail message to a predetermined mail server.

The communication control unit 153 comprises a communication interface circuit, and controls data communication carried out between the server 15 and the user terminals 11 via the network 10.

Below, operations of the e-commerce system according to the present embodiment will be described with focus on the characteristic of the present invention.

A case where a company member (user B) of a customer company (company A) accesses to the website for commerce that a sales company (company C) provides, by applying the user terminal 11, will be described. In this example, it is assumed that the user B has completed a predetermined registering procedure, and user information of the user B is already registered in the user DB 151A of the server 15 of the company C.

The user B operates the user terminal 11, and accesses to the website for commerce that the company C provides. The user terminal 11 accesses to the website for commerce that the server 15 of the company C provides, via the network 10, in accordance with the operation of the user B (L1).

The web server unit 152A, in response to the access from the user terminal 11, reads out data of an input screen for inputting the user ID and password from the storing unit 151, and provides the data to the user terminal 11 (L2). The user terminal 11 displays the input screen on the display, applying the provided data. The user B operates the user terminal 11, and inputs his/her own user ID and password in the displayed input screen. The user terminal 11 sends the input data (user ID and password) to the server 15 of company C, in accordance with the operation of the user B.

The web server unit 152A of the server 15 receives the input data (user ID and password) provided from the user terminal 11 (L3). The web server unit 152A carries out a predetermined authentication processing, applying the received user ID and password, and permits or denies log-in of the user B. In a case where the log-in of the user B is permitted, the web server unit 152A reads out the salesperson information, representative information of company A, and selection information of user B, from the salesperson DB 151B. Then, the web server unit 152A generates data of a commerce screen for the user B, applying the read out information. The web server unit 152A sends the generated data of the commerce screen to the user terminal 11 of the user B (L4).

The user terminal 11 displays the commerce screen to the display, applying the data that is provided from the server 15.

For example, when the user B clicks the introduction button B1 that is provided in the displayed commerce screen, the user terminal 11 sends information indicating that the introduction button B1 has been clicked, to the server 15 of the company C (L5).

The web server unit 152A of the server 15, in response to the information that is provided from the user terminal 11, reads out salesperson information and representative information of company A from the salesperson DB 151B. Sequentially, the web server unit 152A generates data of the introduction screen which shows information of the salespeople who are in charge of the company A, applying the read out information. Then, the web server unit 152A sends the generated data of the introduction screen to the user terminal 11 (L6).

The user terminal 11 displays the introduction screen that shows detailed information of the salespeople who are in charge of the company A, applying data from the server 15. By this, the detailed information of the salespeople who are in charge of the company A, is provided to the user B, and the user B can select the salesperson who meets his/her request.

As described above, the name of the salesperson who is to be a contact person for e-commerce is displayed in the area E2 of the commerce screen. When the user B operates the terminal 11, and selects another name of a salesperson who is in charge of company A, for example “Mr. Jackson”, by the pull down menu, the user terminal 11 sends information showing another salesperson that the user B selected, to the server 15, in accordance with the operation of the user B (L7).

The web server unit 152A of the server 15, in response to the information that is provided from the user terminal 11, reads out information (image, name, attribute, etc.) of another salesperson that the provided information indicates, from the salesperson DB 151B. Then, the web server unit 152A generates data of a commerce screen that has the area E2 which indicates the read information, and sends the data to the user terminal 11 (L8). Furthermore, the web server unit 152A updates the selection information of the user B, which is stored in the salesperson DB 151B, according to the selection of the user B. Concretely, the web server unit 152A rewrites the salesperson ID included in the selection information of user B, to the salesperson ID of another salesperson shown by the provided information. By this, selected salesperson of the user B is changed.

The user terminal 11 displays the commerce screen that has the area E2 which indicates information of another salesperson that the user selected on the display, applying data that is provided from the server 15. By this, information of another salesperson (“Mr. Jackson”) that the user B selected, is displayed in the area E2 of the commerce screen. Thereafter, the selected salesperson of the user B becomes “Mr. Jackson”. For example, in a case where the user B requests an estimate or orders merchandise, Mr. Jackson is set as the contact person for accepting cost estimate requests and orders of merchandise. The salesperson information may include contact information (phone number and e-mail address, etc.) of each salesperson. The web server unit 152A may include the contact information of salespeople to the information shown in the area E1, when generating data of the commerce screen. By doing so, the contact information of the selected salesperson is displayed in the area E1 of the commerce screen. Then, the user B can refer to the displayed contact information, and contact the selected salesperson (“Mr. Jackson”) by phone or e-mail.

When for example, the user B operates the terminal 11, and clicks the contact button B2 that is provided in the commerce screen, the user terminal 11 sends information indicating that the contact button B2 has been clicked (L9).

The web server unit 152A of the server 15, in response to information that is provided from the user terminal 11, generates data of the contact screen, and sends the data to the user terminal 11 (L10).

The user terminal 11 displays the contact screen, applying the data provided from the server 15. The user B confirms the name shown in the input box C1 and phone number and e-mail address shown in the input box C2 of the contact screen, and carries out corrections if necessary. The user B inputs to the predetermined input box C, the contact content to the salesperson to the salesperson, operating the user terminal 11. The user confirms the contact destination shown in the selection box S1, and in a case where the user determines that correction is necessary in the contact destination, the user selects another contact destination from the pull down menu. After input to the contact screen is completed, the user clicks the send button C4, operating the user terminal 11. The user terminal 11, in response to the click of the send button C4, sends the data input to the contact screen to the server 15 (L11).

The web server unit 152 of the server 15, in response to the input data that is provided from the user terminal 11, stores the provided input data to the storing unit 151. Then, the web server unit 152A provides the stored input data to the salesperson who was selected as the contact destination.

As the above, because the selected salesperson that is selected in advance, is shown as the contact destination in the contact screen, and it is possible for the user to change the contact destination to another salesperson, operation for contacting the salesperson becomes easier.

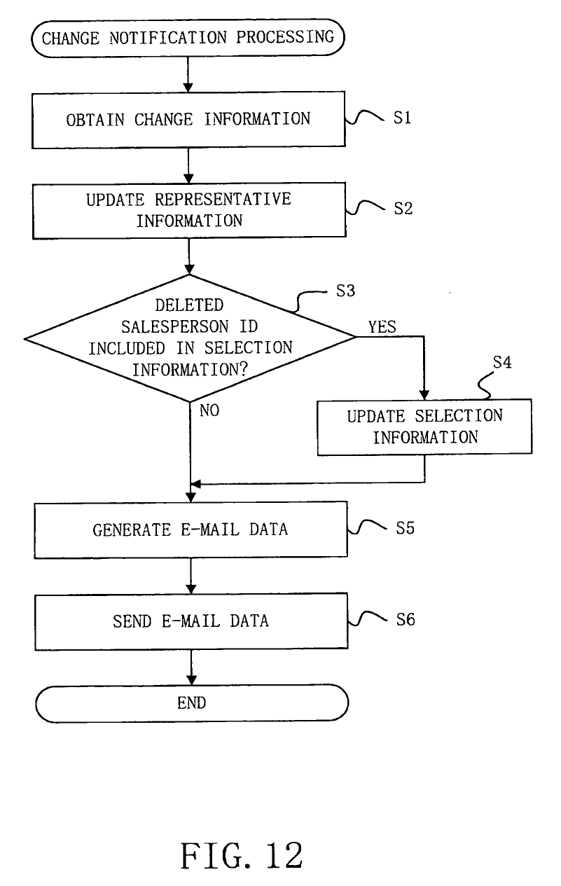

Next, change notification processing that the server 15 carries out, in a case where the salesperson who is in charge of a customer company changes, will be described. Below, an example where a part of the salespeople who are in charge of a company A is changed, will be described with reference to the flowchart in FIG. 12.

First, the server 15 obtains change information that shows change of the salesperson, from a terminal device, etc. that is placed in the sales company, and can connect to the server 15 (Step S1). Change information indicates company ID of company A, where the salesperson is to be changed, salesperson ID of the salesperson who will no longer be in charge of the company A, and the salesperson ID of the salesperson who will newly be in charge of the company A.

Next, the change management unit 152B of the server 15 updates representative information of the company A, which is stored in the salesperson DB 151B, based on the change content that the received change information shows (Step S2). For example, in a case where change information shows company ID “C001” of company A, salesperson ID “A211” of the salesperson who will no longer be in charge, and salesperson ID “A222” of the salesperson who will newly be added to be in charge, etc., the change management unit 152B specifies representative information that includes company ID “C001”, which is stored in the salesperson DB 151B. Then, the change management unit 152B deletes salesperson ID “A211” from the specified representative information, and adds salesperson ID “A222”.

Sequentially, the change management unit 152B determines whether or not the salesperson ID that is deleted from the representative information is included in the selection information of the users who belong to the company A (Step S3).

In a case where it is determined that the salesperson ID that is deleted is included in the selection information (Step S3; YES), the change management unit 152B updates the selection information of the users who belong to the company A, by replacing the salesperson ID that is deleted, included in the selection information, with the sales person ID that is newly added (Step S4). Then, the change management unit 152B, provides the provided change information to the mail management unit 152C.

On the other hand, in a case where it is determined that the salesperson ID that is deleted, is not included in the selection information (STEP S3; NO), the change management unit 152B provides the provided change information to the mail management unit 152C.

The mail management unit 152C obtains user information of the users who belong to the company A, applying the company ID that is shown in the provided change information. Sequentially, the mail management unit 152C obtains the representative information of company A from the salesperson DB 151B, applying the company ID that the provided change information indicates. The mail management unit 152C also obtains form data of e-mail for notifying the change of salesperson, from the storing unit 151. The mail management unit 152C generates data of e-mail, notifying the change of salesperson, for each of the users in the company A, by applying obtained user information, representative information, and form data (Step S5). In this example, the mail management unit 152C creates a message (refer to FIG. 10), by inserting, company name of company A, name of users who belong to the company A (user name), name of the salesperson who is to be deleted, name of the salesperson who is to be added, and representing field of merchandise, etc., to a predetermined part of the form. Then, the mail management unit 152C sets the e-mail address of each user who belongs to the company A, as the destination of the e-mail.

Then, the mail management unit 152C sends data of the generated e-mail to a predetermined mail server, etc (Step S6).

The user terminal 11 of the user who belongs to company A, receives e-mail notifying the change of salesperson who will be in charge of the company A, according to the operation of the user, and displays the e-mail. By this, change of salesperson can be notified accurately and rapidly to each user of the corresponding company.

As described above, according to the present invention, in the e-commerce system, a structure where each company member (user) who belongs to the customer company can select the requested salesperson as the contact person, from the plurality of salespeople who are in charge of that customer company, is realized. By this, burden of business transaction affairs in e-commerce is diffused, and a high processing efficiency can be realized. By providing detailed information of salespeople to the users, criteria for selecting a salesperson can be provided to the users. Because the salesperson that is to be the contact destination is presented to the user, and it is possible to select another salesperson, when inquiring about merchandise, operation for making contact with the salesperson is easy. In a case where change in a salesperson who is in charge of a customer company occurs, the change content can be notified to the company members (users) of that customer company definitely and rapidly.

Screens shown in FIGS. 7 to 9 are just examples, and the structure of each screen is arbitrary. In the above embodiment, at the part which displays the name of the selected salesperson, other salespeople are displayed by pull down. It is not limited to this, and for example, a structure where another screen is displayed for selecting another salesperson from salespeople, is possible.

In the above embodiment, the contact screen is displayed by clicking the contact button B2 of the commerce screen. However, an e-mail creating screen may be displayed instead of the contact screen. At this time, the e-mail creating screen may be structured so that the user can select the requested salesperson as the e-mail sending destination, from the salespeople who are in charge of the customer company that the user belongs to.

In the above embodiment, change information concerning change of salesperson is provided to the server 15 from the terminal device in the sales company. However, change information may be input by operation of an operator, from a not shown input unit of the server 15.

The structure of each terminal that comprises the above e-commerce system may be arbitrarily modified. For example, the server 15 may be comprised of a plurality of computers that cooperatively operate. At least one of the user DB 151A or the sales person DB 151B may be included in another computer that is possible to be connected to the server 15. One or a plurality of information that is stored in the user DB 151A and the salesperson DB 151B may be stored in another computer that is possible to be connected to the server 15.

Merchandise that are sales targets are not limited to electronic products, such as shown in FIG. 7. For example, merchandise may be music data, image data, motion picture data, or research estimates concerning items that customer companies designate. Representatives who are in charge of a customer company are not limited to the above representatives. For example, in a case where the merchandise that is the sales target is research estimates, representatives may be annalists who analyze the research estimates.

The sales target of merchandise is not limited to the above companies. Various organizations where a plurality of users belong, may be sales targets (customers).

The system of the present invention can be realized by a general computer, without the need for a dedicated system. For example, the user terminal 11 and the server 15, etc. that carry out the above processing, may be structured by installing to the computer, a program for controlling the computer to execute the above-described procedures, which the program may be recorded on a medium (an FD, a CD-ROM, a DVD or the like), and distributed. The program may be stored in a disk device or the like of the server device on the Internet. The program embedded in the carrier wave may be downloaded into the computer so as to realize the apparatus of the present invention.

In a case where the above function is realized by the OS or the OS and application, only the part besides the OS may be stored in a medium and distributed, or may be downloaded to the computer, being embedded in a carrier wave.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application NO. 2002-343487 filed on Nov. 27, 2002, and including specification, claims, drawings and summary. The disclosure of the above Japanese Patent Application is incorporated herein by reference in its entirety.

What is claimed is:

1. A management method for managing representatives in e-commerce system that is carried out using computers, comprising:
a first storing step of storing, by a management terminal that manages said representatives, representative information indicating a plurality of representatives who are in charge of an organization that a user belongs to, and selection information indicating a selected representative who is selected from a plurality of representatives by the user;
a screen generating step of generating, by said management terminal, data of a first screen which indicates the selected representative that the selection information indicates, where it is possible for the user to select on the screen, another representative than said selected representative, from said plurality of representatives that the representative information indicates;
a screen sending step of sending, by said management terminal, data of said first screen to a user terminal operated by the user; and
a displaying step of displaying, by said user terminal, the first screen by using the provided data of the first screen.

2. The management method according to claim 1, further comprising:
an information sending step of sending, by the user terminal, representative change information indicating said another representative selected by the user to the management terminal, in a case where the user selects said another representative on the first screen; and
an updating step of updating, by the management terminal, the selection information, using the provided representative change information, and by this, setting said another representative that the user selected, as a newly selected representative.

3. The management method according to claim 2, wherein the first screen is for displaying information of merchandise, which the management terminal provides.

4. The management method according to claim 1, wherein the first screen is for inputting contact content to the selected representative from the user, and indicates the selected representative as a contact destination.

5. The management method according to claim 4, further comprising;
a first providing step of providing contact content that the user input in the first screen, by said user terminal, to the management terminal; and
a second providing step of providing, by the management terminal, the provided contact content to the selected representative.

6. The management method according to claim 5, further comprising an information sending step of sending, by the user terminal, contact destination change information indicating said another representative that the user selected, to the management terminal, in a case where the user selects another representative on the first screen, wherein
the second providing step comprises a step of providing the contact content, by the management terminal, to said another representative that the contact change information indicates.

7. The management method according to claim 6, wherein the second providing step comprises a step of providing contact content from the user, by e-mail.

8. The management method according to claim 1, further comprising:
a second storing step of storing, by the management terminal, user information concerning a plurality of users who belong to said organization; and
a notifying step of notifying, by the management terminal, change of representative to each of the plurality of users that the user information indicates, in a case where at least one of the plurality of representatives who are in charge of the organization changes.

9. The management method according to claim 8, wherein the notifying step comprises a step of notifying each of the plurality of users of the change of representative, by the management terminal sending e-mail indicating the change of the representative to each of the plurality of users.

10. A management terminal that manages representatives in e-commerce, using a computer, comprising:
a memory, which stores representative information indicating a plurality of representatives who are in charge of an organization that a user belongs to, and selection information indicating a selected representative who is selected from the plurality of representatives by the user;
a screen generating unit that generates data of a first screen, which displays the selected representative that the selection information indicates, and which is possible for the user to select another representative than said selected representative on the first screen; and
a screen sending unit which sends data of the first screen to a user terminal that the user uses, so that the first screen is displayed on the user terminal.

11. The management terminal according to claim 10, further comprising an updating unit, which updates the selection information, using representative change information provided from the user terminal indicating said another representative that the user selected, and by this, sets said another representative that the user selected as a newly selected representative, in a case where the user selects said another representative on the first screen.

12. The management terminal according to claim 11, wherein the first screen indicates information of merchandise, which the management terminal provides.

13. The management terminal according to claim 10, wherein the first screen is for inputting contact content to the selected representative from the user, and indicates the selected representative as the contact destination.

14. The management terminal according to claim 13, comprising a providing unit that provides the contact content which is input on the first screen by the user, and is provided from the user terminal, to the selected representative.

15. The management terminal according to claim 14, wherein the providing unit provides the contact content to another representative, which is indicated by a contact destination change information indicating said another representative that the user selected on the first screen, and which is provided from the user terminal, in a case where the user selects said another representative on the first screen.

16. The management terminal according to claim 15, wherein the providing unit provides the contact content from the user terminal, by e-mail.

17. The management terminal according to claim 10, wherein said memory stores user information concerning a plurality of users who belong to said organization, and said management terminal further comprises a notifying unit which notifies change of representative to each of the plurality of users that the user information indicates, in a case where at least one of the plurality of representatives who are in charge of said organization changes.

18. The management terminal according to claim 17, wherein said notifying unit notifies each of the plurality of users of the change of representative, by sending e-mail indicating the change of representative to each of the plurality of users.

19. A program for controlling a computer to function as a management terminal that manages representatives in e-commerce, comprising:
a memory which stores representative information indicating a plurality of representatives who are in charge of an organization that a user belongs to, and selection information indicating a selected representative who is selected from the plurality of representatives by the user;
a screen generating unit that generates data of a first screen, which displays the selected representative that the selection information indicates, and which is possible for the user to select another representative than said selected representative; and
a screen sending unit which sends data of the first screen to a user terminal that the user uses, so that the first screen is displayed on the user terminal.
